(19) United States
(12) Patent Application Publication
(10) Pub. No.: US 2026/0330290 A1
(43) Pub. Date: Oct. 22, 2026

(54) SYSTEM AND METHOD FOR RETRAINING AN ARTIFICIAL INTELLIGENCE MODEL

(71) Applicant: The Toronto-Dominion Bank, Toronto (CA)

(72) Inventors: Shahriar TAHERI, Newmarket (CA); Mohsen RAZA, Toronto (CA)

(73) Assignee: The Toronto-Dominion Bank, Toronto (CA)

(21) Appl. No.: 19/180,306

(22) Filed: Apr. 16, 2025

(51) Int. Cl. G06N 20/00

(52) U.S. Cl. CPC G06N 20/00

(57) ABSTRACT

A computer system comprises a communications module; at least one processor coupled with the communications module; and a memory coupled to the at least one processor and storing processor-executable instructions which, when executed by the at least one processor, configure the at least one processor to identify at least one feature contributing to at least one error made by an artificial intelligence model; reduce a gain of the identified at least one feature; and retrain the artificial intelligence model using the reduced gain of the identified at least one feature.

### TECHNICAL FIELD

The present application relates to systems and methods for retraining an artificial intelligence model.

### BACKGROUND

The rapid evolution of patterns in dynamic data streams presents a technical challenge for AI-based systems, as traditional machine learning models trained on static datasets become increasingly ineffective over time. As patterns evolve, these machine learning models struggle to adapt to new, unseen behaviors, leading to performance degradation and reduced system reliability.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence engine;

FIG. 4 shows, in flowchart form, an example method for identifying at least one error made by an artificial intelligence model;

FIG. 5 shows, in flowchart form, an example method for retraining an artificial intelligence model;

FIG. 6 is an example Shapley Additive exPlanation (SHAP) summary plot generated for a false positive prediction;

FIG. 7 is an example SHAP summary plot generated for a false negative prediction; and

FIG. 8 shows, in flowchart form, an example method for triggering the retraining of an artificial intelligence model.

Like reference numerals are used in the drawings to denote like elements and features.

### DETAILED DESCRIPTION OF VARIOUS EMBODIMENTS

Accordingly, in one aspect there is provided a computer system comprising a communications module; at least one processor coupled with the communications module; and a memory coupled to the at least one processor and storing processor-executable instructions which, when executed by the at least one processor, configure the at least one processor to identify at least one feature contributing to at least one error made by an artificial intelligence model; reduce a gain of the identified at least one feature; and retrain the artificial intelligence model using the reduced gain of the identified at least one feature.

In one or more embodiments, reducing the gain of the identified at least one feature adjusts a contribution of the at least one feature during the retraining.

In one or more embodiments, the artificial intelligence model includes an XGBoost model.

In one or more embodiments, the processor-executable instructions, when executed by the at least one processor, further configure the at least one processor to generate Shapley Additive exPlanation (SHAP) values for the at least one error made by the artificial intelligence model; and analyze the SHAP values to identify the at least one feature contributing to the at least one error.

In one or more embodiments, the at least one feature contributing to the at least one error includes at least one feature having a maximum SHAP value or at least one feature having a minimum SHAP value.

In one or more embodiments, the at least one error includes at least one of a false positive or a false negative.

In one or more embodiments, the at least one error is generated based on at least one validation dataset.

In one or more embodiments, the processor-executable instructions, when executed by the at least one processor, further configure the at least one processor to monitor a performance of the artificial intelligence model; determine that the performance has dropped below a threshold; and retrain the model.

In one or more embodiments, the threshold includes a number or percentage of false negatives or false positives.

In one or more embodiments, when monitoring the performance of the artificial intelligence model, the processor-executable instructions, when executed by the at least one processor, further configure the at least one processor to periodically compare predictions made by the artificial intelligence model against ground truth to identify the at least one error made by the artificial intelligence model.

In one or more embodiments, when monitoring the performance of the artificial intelligence model, the processor-executable instructions, when executed by the at least one processor, further configure the at least one processor to track distribution of input features to identify changes in the input features that reduce accuracy.

According to another aspect there is provided a computer-implemented method comprising identifying at least one feature contributing to at least one error made by an artificial intelligence model; reducing a gain of the identified at least one feature; and retraining the artificial intelligence model using the reduced gain of the identified at least one feature.

In one or more embodiments, reducing the gain of the identified at least one feature adjusts a contribution of the at least one feature during the retraining.

In one or more embodiments, the artificial intelligence model includes an XGBoost model.

In one or more embodiments, the method further comprises generating Shapley Additive exPlanation (SHAP) values for the at least one error made by the artificial intelligence model, and analyzing the SHAP values to identify the at least one feature contributing to the at least one error.

In one or more embodiments, the at least one feature contributing to the at least one error includes at least one feature having a maximum SHAP value or at least one feature having a minimum SHAP value.

In one or more embodiments, the at least one error includes at least one of a false positive or a false negative.

In one or more embodiments, the at least one error is generated based on at least one validation dataset.

In one or more embodiments, the method further comprises monitoring a performance of the artificial intelligence model; determining that the performance has dropped below a threshold; and retraining the model.

In one or more embodiments, the threshold includes a number or percentage of false negatives or false positives.

In one or more embodiments, when monitoring the performance of the artificial intelligence model, the method further comprises periodically comparing predictions made by the artificial intelligence model against ground truth to identify the at least one error made by the artificial intelligence model.

According to another aspect there is provided a non-transitory computer readable storage medium comprising computer-executable instructions which, when executed, configure a processor to identify at least one feature contributing to at least one error made by an artificial intelligence model; reduce a gain of the identified at least one feature; and retrain the artificial intelligence model using the reduced gain of the identified at least one feature.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of …or…” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

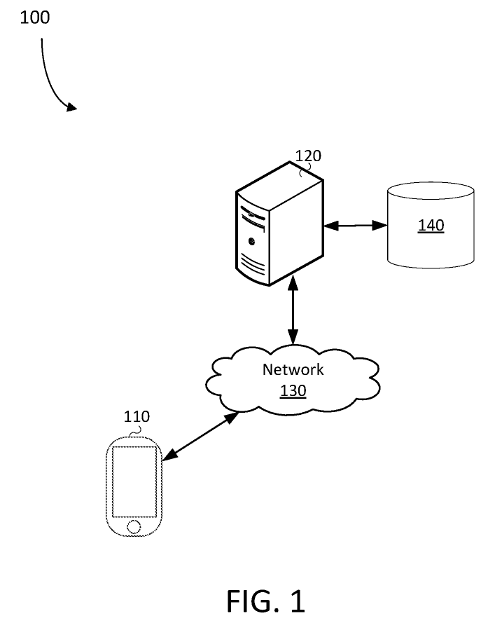

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include a database system and may maintain a database 140 that includes various data records. The data records may include one or more datasets where each dataset may include one or more features having one or more feature values. The database 140 may store at least some of the data in rows such that each row combines all features for a data point. At least one of the datasets may include a training dataset that may be used to train one or more artificial intelligence models to generate predictions. At least one of the datasets may include a validation dataset that may be used to evaluate the performance of one or more artificial intelligence models.

The server computer system 120 may include an artificial intelligence engine that may include the one or more artificial intelligence models trained to generate predictions. As will be described in more detail, the artificial intelligence engine may include, among other modules, a Shapley Additive exPlanations (SHAP) analysis module to identify at least one feature contributing to one or more errors made by the artificial intelligence engine and a feature adjustment module to adjust the weight or importance of the identified at least one feature.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

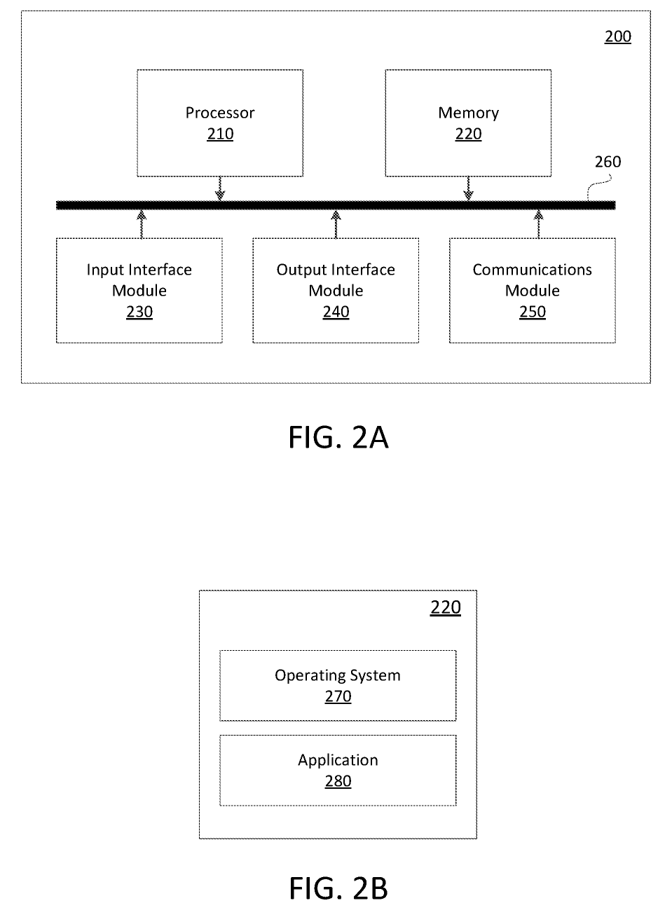

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi (TM), using Bluetooth (TM) or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS^{TM}, Google Android^{TM}, Linux^{TM}, Microsoft Windows^{TM}, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

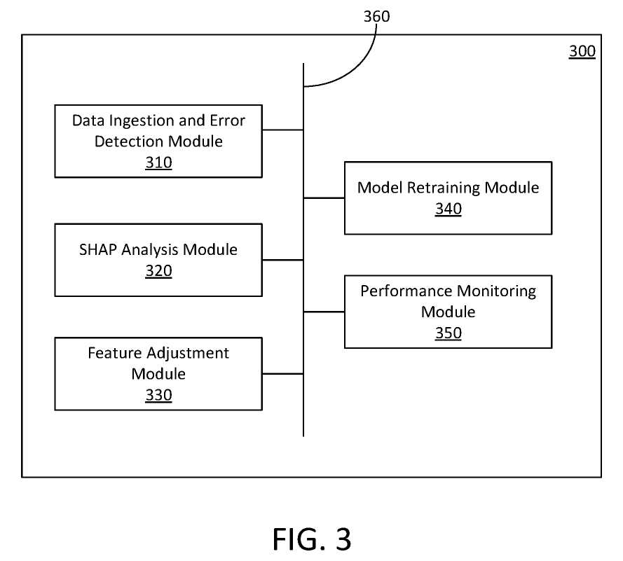

As mentioned, the artificial intelligence engine may include one or more artificial intelligence models trained to generate predictions, a Shapley Additive exPlanations (SHAP) analysis module to identify at least one feature contributing to one or more errors made by the artificial intelligence engine and a feature adjustment module to adjust the weight or importance of the identified at least one feature. FIG. 3 is an example schematic diagram outlining various components of an artificial intelligence engine 300. As can be seen, the artificial intelligence engine 300 includes a data ingestion and error detection module 310, a SHAP analysis module 320, a feature adjustment module 330, a model retraining module 340, and a performance monitoring module 350. The various components communicate with one another over a pipeline 360.

The data ingestion and error detection module 310 may include an artificial intelligence model trained to generate predictions. In one or more embodiments, the artificial intelligence model may include one or more tree-based modules such as for example Random Forests and/or Gradient Boosted Trees such as for example XGBoost. The data ingestion and error detection module 310 may continuously ingest data and may make predictions on the data using the artificial intelligence model. As will be described in more detail below, the data ingestion and error detection module 310 may identify at least one error made by the artificial intelligence model such as for example a false positive prediction or a false negative prediction. To identify the at least one error, the data ingestion and error detection module 310 may compare the artificial intelligence models predictions with actual outcomes.

The SHAP analysis module 320 may perform SHAP analysis on predictions generated by the artificial intelligence model to explain the contribution of each feature. For example, the SHAP analysis module 320 may perform SHAP analysis to generate SHAP values for at least one error made by the artificial intelligence model to identify at least one feature contributing to the at least one error. Further operations performed by the SHAP analysis module 320 will be described in more detail below.

The feature adjustment module 330 may adjust the weight or importance of the features identified as contributing to errors based on the SHAP analysis.

The model retraining module 340 may retrain the artificial intelligence model with updated data and adjusted feature importance. The model retraining module 340 may utilize techniques such as for example incremental learning to update the artificial intelligence model without having to retrain the artificial intelligence model from scratch.

The performance monitoring module 350 continuously tracks the artificial intelligence models performance which may include determining a false positive rate or a false negative rate. The performance monitoring module 350 may trigger retraining of the artificial intelligence model if errors persist or performance drops.

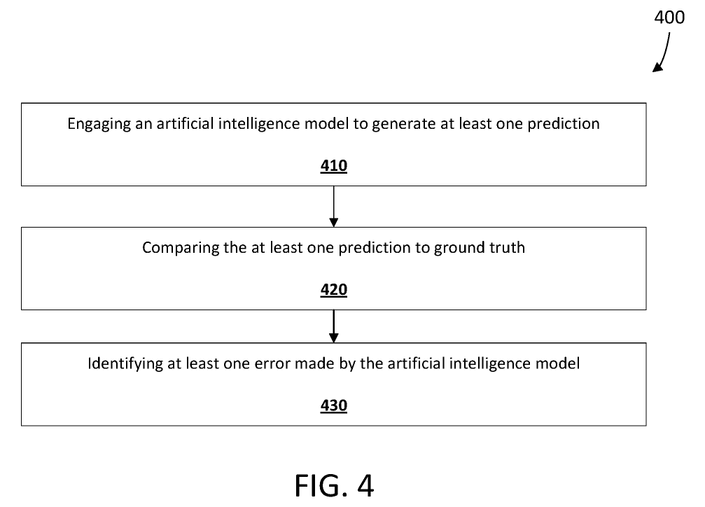

Reference is made to FIG. 4, which illustrates, in flowchart form, a method 400 for identifying at least one error made by an artificial intelligence model. The method 400 may be implemented by a computing device having suitable processor-executable instructions for causing the computing device to carry out the described operations. The method 400 may be implemented, in whole or in part, by the server computer system 120. At least some of the operations may be performed by one or more modules of the artificial intelligence engine such as for example the data ingestion and error detection module 310.

The method 400 includes engaging an artificial intelligence model to generate at least one prediction (step 410).

In one or more embodiments, when a new data point is fed into the artificial intelligence model, the artificial intelligence model generates a prediction. In one or more embodiments, the prediction may include a prediction as to whether or not the new data point represents fraud or non-fraud.

In one or more embodiments, the artificial intelligence model that may output a probability indicating the likelihood of a given instance being in a certain class. For example, the artificial intelligence model may perform binary classification (e.g. fraud vs. non-fraud) and may output a probability (e.g., between 0 and 1) indicating the likelihood of a given instance being in a certain class. For example, if the probability of fraud is greater than or equal to a threshold, such as for example 0.5, the prediction is “fraud” and if the probability is less than the threshold, the prediction is “non-fraud”. The threshold may be defined for the artificial intelligence model during training and the choice of the threshold may affect how many false positive or false negative errors occur. For example, lowering the threshold may reduce false negatives but may increase false positives.

In one or more embodiments, the at least one prediction may be generated based on at least one validation dataset that includes at least one data point and at least one ground truth for the at least one data point.

The method 400 includes comparing the at least one prediction to ground truth (step 420).

The ground truth may include the actual outcome for the data point. For example the ground truth may be defined as “fraud” or “non-fraud” based on the actual outcome.

The at least one prediction may be classified based on the comparison between the predicted label and the actual ground truth label. The prediction may be classified as a true positive when the artificial intelligence model correctly predicts fraud as fraud and a true negative when the artificial intelligence model correctly predicts non-fraud as non-fraud.

The prediction may be classified as an error when the prediction is incorrect. For example, the error may be defined as a false positive when the artificial intelligence model incorrectly predicts fraud when it is actually non-fraud. The error may be defined as a false negative when the model incorrectly predicts non-fraud when it is actually fraud.

The method 400 includes identifying at least one error made by the artificial intelligence model (step 430).

The at least one error is identified in response to determining that the prediction made by the artificial intelligence model is a false positive or a false negative. The at least one error may be logged in a database for further analysis and tracking.

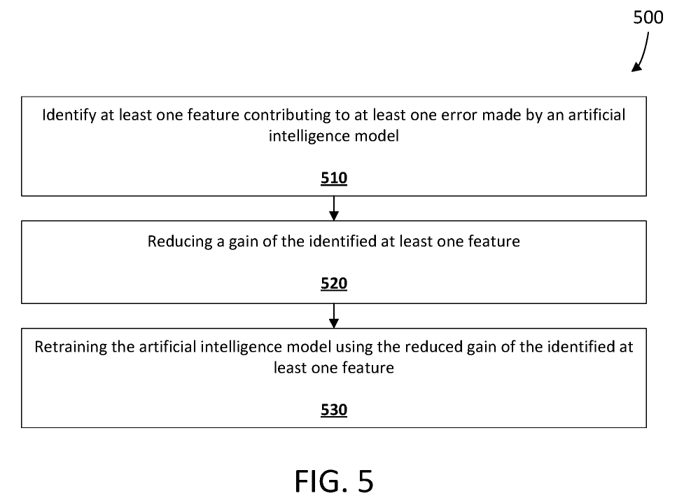

The artificial intelligence model may be retrained based on the identification of the at least one error. Reference is made to FIG. 5, which illustrates, in flowchart form, a method 500 for retraining an artificial intelligence model. The method 500 may be implemented by a computing device having suitable processor-executable instructions for causing the computing device to carry out the described operations. The method 500 may be implemented, in whole or in part, by the server computer system 120. At least some of the operations may be performed by one or more modules of the artificial intelligence engine.

The method 500 includes identifying at least one feature contributing to at least one error made by an artificial intelligence model (step 510).

In one or more embodiments, when identifying the at least one feature contributing to the at least one error, the server computer system 120 may generate Shapley Additive exPlanation (SHAP) values for the at least one error made by an artificial intelligence model. The SHAP values explain the contribution of each feature to the model’s prediction. For example, the SHAP values explain the contribution of each feature to the at least one error made by the artificial intelligence model.

In one or more embodiments, the SHAP values may be generated using a SHAP library such as that available in Python. For example, the SHAP library may be installed. An appropriate SHAP explainer may be initialized and this may be based on the artificial intelligence model used to generate the prediction. Example SHAP explainers include TreeExplainer, DeppExplainer, LinearExplainer, etc. In one or more embodiments, one or more visualization tools may be utilized such as for example Summary Plot, Force Plot, Dependence Plot, etc.

The SHAP values may be analyzed to identify at least one feature contributing to the at least one error. In one or more embodiments, features having the highest or lowest SHAP values may be identified. For example, features having the highest SHAP values may be identified as features contributing to a false positive prediction and features having the lowest SHAP values may be identified as features contributing to a false negative prediction.

In one or more embodiments, identifying at least one feature may include identifying a single feature that contributes to the at least one error. As one example, where the at least one error includes a false positive prediction, the SHAP values may be analyzed to identify a single feature that has the highest SHAP value. As another example, where the at least one error includes a false negative prediction, the SHAP values may be analyzed to identify a single feature that has the lowest (or most negative) SHAP value.

In one or more embodiments, identifying at least one feature may include identifying more than one feature that contributes to the at least one error and this may be based on a threshold SHAP value. As one example, where the at least one error includes a false positive prediction, the SHAP values may be analyzed to identify all features that have a SHAP value greater than the threshold SHAP value. As another example, where the at least one error includes a false negative prediction, the SHAP values may be analyzed to identify all features that have a SHAP value less than the threshold SHAP value. It will be appreciated that the threshold SHAP value may be adjusted or fine-tuned and this may be based on model interpretability, noise control, performance considerations, etc.

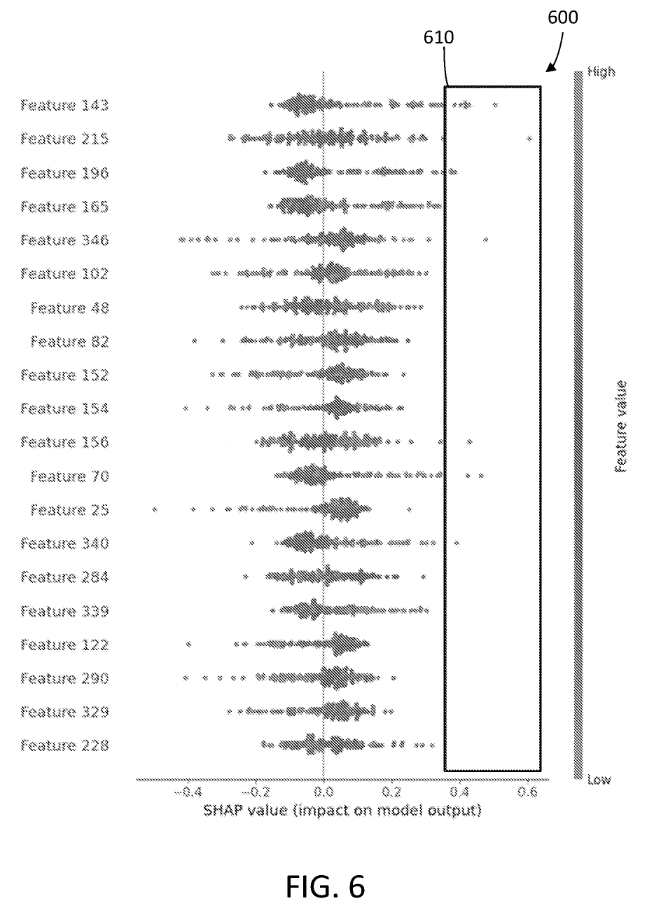

An example SHAP summary plot 600 generated for a false positive prediction is shown in FIG. 6. The SHAP summary plot 600 is in the form of a beeswarm plot that visualizes the distribution of SHAP values for all features across all samples. The beeswarm plot uses dots to represent individual SHAP values for each sample, illustrating the distribution and relative importance of each feature in the model. In this example, a threshold SHAP value may be defined as 0.38 and as such any feature having a SHAP value greater than 0.38 may be identified as contributing to the false positive prediction. For illustrative purposes, a threshold boundary 610 is shown where a feature associated with a feature value within the threshold boundary 610 is identified as contributing to the false positive prediction. In this specific example, features 143, 215, 346, 156, 70 and 340 are identified as contributing to the false positive prediction.

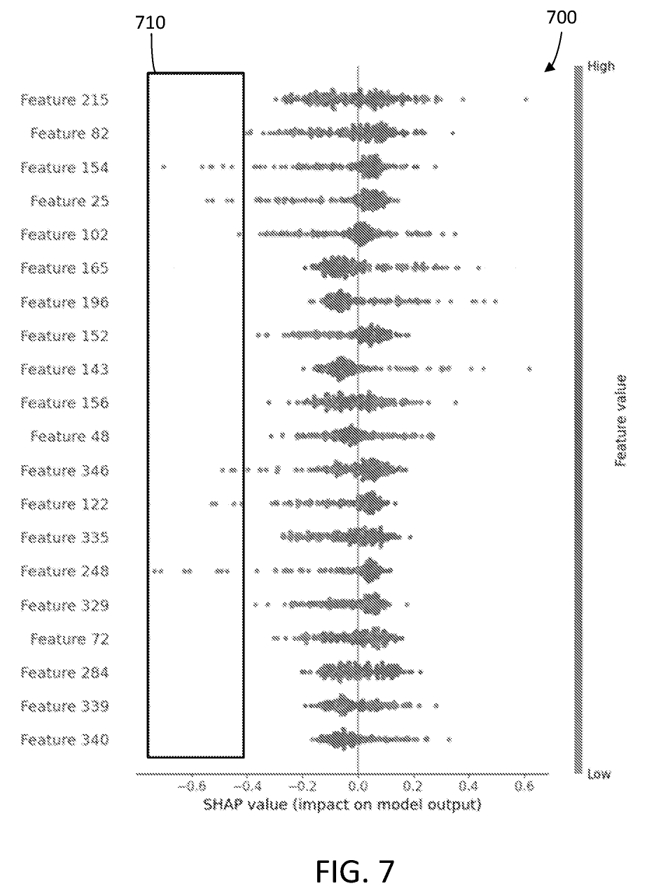

Another example SHAP summary plot 700 generated for a false negative prediction is shown in FIG. 7. The SHAP summary plot 700 is in the form of a beeswarm plot that visualizes the distribution of SHAP values for all features across all samples. The beeswarm plot uses dots to represent individual SHAP values for each sample, illustrating the distribution and relative importance of each feature in the model. In this example, a threshold SHAP value may be defined as -0.4 and as such any feature having a SHAP value less than -0.4 may be identified as contributing to the false negative prediction. For illustrative purposes, a threshold boundary 710 is shown where a feature associated with a feature value within the threshold boundary 710 is identified as contributing to the false negative prediction. In this specific example, features 154, 25, 102, 346, 122 and 248 are identified as contributing to the false negative prediction.

The method 500 includes reducing a gain of the identified at least one feature (step 520).

Responsive to identifying the at least one feature as contributing to the at least one error, the gain of the identified at least one feature is reduced to adjust the weight or importance of the at least one feature in the model. For example, in embodiments where the artificial intelligence model includes a tree-based model, the gain of the identified at least one feature may be reduced by lowering the weight or importance of the at least one feature in the model.

In one or more embodiments, reducing the gain of the at least one feature may be performed by adjusting hyperparameters such as learning rate or feature importance constraints in the model. In one or more embodiments, reducing the gain of the at least one feature may include scaling the feature.

It will be appreciated that the amount of the gain may depend on the artificial intelligence model and the type of data analyzed by the artificial intelligence model. In one or more embodiments, the gain may be reduced incrementally where a small reduction in gain such as for example 10 % may be used and this may be done to avoid underfitting or overfitting. Different reductions such as for example 10 %, 25 %, 50 % may be used in a controlled manner and cross-validation may be used to assess the impact of the change on the model performance.

The method 500 includes retraining the artificial intelligence model using the reduced gain of the identified at least one feature (step 530).

The artificial intelligence model is retrained using the reduced gain of the identified at least one feature. Put another way, the artificial intelligence model may be retrained using the updated feature weights or values. By reducing the gain of the at least one feature identified as contributing to at least one error, the artificial intelligence model may be retrained to adjust to the new influence of the at least one feature. Put another way, reducing the gain of the identified at least one feature adjusts a contribution of the at least one feature during the retraining.

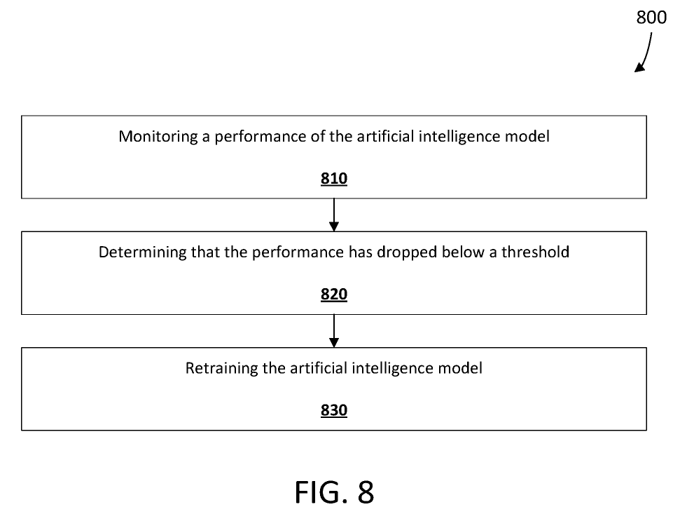

The retraining of the artificial intelligence model may be performed periodically in response to changes in artificial intelligence model performance and/or changes in in input features. Reference is made to FIG. 8, which illustrates, in flowchart form, a method 800 for triggering the retraining of the artificial intelligence model. The method 800 may be implemented by a computing device having suitable processor-executable instructions for causing the computing device to carry out the described operations. The method 800 may be implemented, in whole or in part, by the server computer system 120. At least some of the operations may be performed by one or more modules of the artificial intelligence engine.

The method 800 includes monitoring a performance of the artificial intelligence model (step 810).

In one or more embodiments, to monitor the performance of the artificial intelligence model, predictions made by the artificial intelligence model may be periodically compared to ground truth to identify at least one error made by the artificial intelligence model. Using the at least one error made by the artificial intelligence model, an error rate may be calculated and this may include a percentage of errors made by the artificial intelligence model. The error rate may include at least one of a false negative rate and a false positive rate.

In one or more embodiments, to monitor the performance of the artificial intelligence model, the distribution of input features may be tracked to identify changes in the input features that reduce accuracy. For example, over time the distribution of features may change due to factors such as changes in the data source, changes in behavior, etc. These changes may be tracked by comparing the current distribution to the historical distribution. To identify these changes, the distribution of values of each feature or input variable may be monitored and mean, variance, skewness, range, etc. of each feature may be determined. It will be appreciated that when the distribution of input features changes significantly, such as for example more than a threshold amount, the artificial intelligence model may encounter data different than it was originally trained on due to data drift or concept drift and this may cause the artificial intelligence model to make less accurate predictions. By tracking these changes, the degradation of the artificial intelligence model’s accuracy may be identified.

The method 800 includes determining that the performance has dropped below a threshold (step 820).

In one or more embodiments, the threshold may include a number or percentage of errors such as false negatives or false positives made by the artificial intelligence model. For example, it may be determined that the false positive rate of the artificial intelligence model has dropped below a threshold value of 5 %.

The method 800 includes retraining the artificial intelligence model (step 830).

Responsive to determining that the performance has dropped below the threshold, the retraining of the artificial intelligence model may be automatically triggered and operations to retrain the artificial intelligence model may be performed in accordance with embodiments described herein.

In manners described herein, by reducing the gain of at least one feature contributing to at least one error made by the artificial intelligence model, the performance of the artificial intelligence model is improved. For example, adjusting the gain of the at least one feature may improve the artificial intelligence model’s performance by fine-tuning how much influence a particular feature has on the predictions. This adjustment helps address issues such as false positives, false negatives, or model bias leading to a more balanced and accurate model. For example, if a feature is contributing to too many false positives, reducing the gain of this feature means the artificial intelligence model will place less weight on this feature, leading to fewer false positives. Further, by adjusting the gain, the influence of features is controlled and this may serve to help overfitting. For instance, a feature that is too highly weighted may cause the artificial intelligence model to fit too closely to the training data which may lead to poor generalization on unseen data. Adjusting the gain of such features may make the artificial intelligence model more robust and improve its ability to generalize, reducing the risk of overfitting. Still further, adjusting the gain of features can help improve model interpretability by making it easier to see which features are driving the artificial intelligence model’s decisions. This is especially useful in cases where some features are less meaningful or contributing to noise. By reducing the gain of such features, the artificial intelligence model becomes more focused on the truly important variables, making it easier to understand and explain the decisions.

In manners described herein, if a feature has an unreasonably high gain, it may be introducing bias into the artificial intelligence model’s predictions. For example, a feature related to user demographics may disproportionately affect the artificial intelligence model’s decision to flag transactions as fraudulent. By reducing the gain of such a feature, the artificial intelligence model is able to make a more fair and balanced prediction reducing the risk of discriminatory outcomes.

Further, by reducing the gain of the at least one feature contributing to the at least one error rather than removing the at least one feature completely, the artificial intelligence model may still benefit from any useful signal that the at least one feature provides but the influence of the at least one feature is reduced.

Further, since the at least one feature may interact with other features, removing it entirely could have unforeseen consequences including distorting the artificial intelligence model’s understanding of these relationships. As such, by reducing the gain of the at least one feature, the at least one feature still contributes to the artificial intelligence models prediction but with a controlled influence which may help strike a balance between reducing errors and maintaining model performance.

In accordance with embodiments described herein, even if a feature is identified as contributing to errors, the at least one feature may still hold valuable information when it is combined with other features. By reducing the gain of the at least one feature, the artificial intelligence model retains the information but at a controlled level.

Reducing gain of the at least one feature in accordance with embodiments described herein provides a more controlled approach than outright removal, which may lead to instability or poor performance.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
a communications module;
at least one processor coupled with the communications module; and
a memory coupled to the at least one processor and storing processor-executable instructions which, when executed by the at least one processor, configure the at least one processor to:
identify at least one feature contributing to at least one error made by an artificial intelligence model;
reduce a gain of the identified at least one feature; and
retrain the artificial intelligence model using the reduced gain of the identified at least one feature.

2. The computer system of claim 1, wherein reducing the gain of the identified at least one feature adjusts a contribution of the at least one feature during the retraining.

3. The computer system of claim 1, wherein the artificial intelligence model includes an XGBoost model.

4. The computer system of claim 1, wherein the processor-executable instructions, when executed by the at least one processor, further configure the at least one processor to:
generate Shapley Additive exPlanation (SHAP) values for the at least one error made by the artificial intelligence model; and
analyze the SHAP values to identify the at least one feature contributing to the at least one error.

5. The computer system of claim 4, wherein the at least one feature contributing to the at least one error includes at least one feature having a maximum SHAP value or at least one feature having a minimum SHAP value.

6. The computer system of claim 1, wherein the at least one error includes at least one of a false positive or a false negative.

7. The computer system of claim 1, wherein the at least one error is generated based on at least one validation dataset.

8. The computer system of claim 1, wherein the processor-executable instructions, when executed by the at least one processor, further configure the at least one processor to:
monitor a performance of the artificial intelligence model;
determine that the performance has dropped below a threshold; and
retrain the model.

9. The computer system of claim 8, wherein the threshold includes a number or percentage of false negatives or false positives.

10. The computer system of claim 8, wherein when monitoring the performance of the artificial intelligence model, the processor-executable instructions, when executed by the at least one processor, further configure the at least one processor to:
periodically compare predictions made by the artificial intelligence model against ground truth to identify the at least one error made by the artificial intelligence model.

11. A computer-implemented method comprising:
identifying at least one feature contributing to at least one error made by an artificial intelligence model;
reducing a gain of the identified at least one feature; and
retraining the artificial intelligence model using the reduced gain of the identified at least one feature.

12. The computer-implemented method of claim 11, wherein reducing the gain of the identified at least one feature adjusts a contribution of the at least one feature during the retraining.

13. The computer-implemented method of claim 11, wherein the artificial intelligence model includes an XGBoost model.

14. The computer-implemented method of claim 11, further comprising:
generating Shapley Additive exPlanation (SHAP) values for the at least one error made by the artificial intelligence model; and
analyzing the SHAP values to identify the at least one feature contributing to the at least one error.

15. The computer-implemented method of claim 14, wherein the at least one feature contributing to the at least one error includes at least one feature having a maximum SHAP value or at least one feature having a minimum SHAP value.

16. The computer-implemented method of claim 11, wherein the at least one error includes at least one of a false positive or a false negative.

17. The computer-implemented method of claim 11, wherein the at least one error is generated based on at least one validation dataset.

18. The computer-implemented method of claim 11, further comprising:
monitoring a performance of the artificial intelligence model;
determining that the performance has dropped below a threshold; and
retraining the model.

19. The computer-implemented method of claim 18, wherein when monitoring the performance of the artificial intelligence model, the method further comprises:
periodically comparing predictions made by the artificial intelligence model against ground truth to identify the at least one error made by the artificial intelligence model.

20. A non-transitory computer readable storage medium comprising computer-executable instructions which, when executed, configure a processor to:
identify at least one feature contributing to at least one error made by an artificial intelligence model;
reduce a gain of the identified at least one feature; and
retrain the artificial intelligence model using the reduced gain of the identified at least one feature.
